(19) United States
(12) Patent Application Publication
(10) Pub. No.: US 2026/0057140 A1
(43) Pub. Date: Feb. 26, 2026

(54) COMPUTER-IMPLEMENTED METHODS AND COMPUTING SYSTEMS FOR GENERATING AN OPTIMAL GRADING DESIGN

(71) Applicant: Site Suite, Inc, Soquel, CA (US)

(72) Inventors: Christian Lucas Kjeldsen, Soquel, CA (US); Lincoln Evans-Beauchamp, Soquel, CA (US)

(21) Appl. No.: 19/303,985

(22) Filed: Aug. 19, 2025

Related U.S. Application Data
(60) Provisional application No. 63/684,881, filed on Aug. 20, 2024.

(51) Int. Cl. G06F 30/20; G06F 111/02

(52) U.S. Cl. CPC G06F 30/20; G06F 2111/02

(57) ABSTRACT

Methods and systems for generating an optimal grading design are disclosed. The method performed by the system includes generating a topography profile of a plot of land. The method includes appending a plurality of boundaries to the topology profile. The method includes determining whether a grading design satisfies usage constraints based, at least in part, on the topography profile and a usage map. Herein, the usage map includes a plurality of usage areas and corresponding usage parameters. The method includes accessing a cost profile including a plurality of individual costs associated with respective land restructuring operations of the plot of land. The method includes generating a modified topography profile based on the topography profile and the cost profile associated with the respective land restructuring operations of the plot of land.

### TECHNICAL FIELD

The present disclosure relates generally to the automation of manual processes involved in land development, and more particularly relates to the generation of optimal grading designs while minimizing the costs involved.

### BACKGROUND

All new infrastructure development requires grading design to shape the land to meet the needs of the project. Grading design is a process used in engineering, architecture, and landscape design to shape the surface of a given plot of land. It involves planning and implementing changes to the topography of a site to achieve specific goals, such as ensuring proper drainage, creating a level base for construction, or improving aesthetic appeal. Typical processes involved in grading design include (1) conducting a survey to understand the existing elevations and contours of the site, (2) designing slopes and grades to manage water runoff and prevent erosion or flooding, (3) determining the amount of soil that needs to be excavated (cut) or added (fill) to achieve the desired landform, (4) implementing techniques to stabilize slopes and prevent landslides or erosion, (5) shaping the land to enhance visual appeal and integrate with the surrounding environment, (6) ensuring the grading plan complies with local zoning laws, building codes, and environmental regulations, and (7) providing detailed instructions for construction, including grading limits, materials, and methods.

At a higher level, projects are designed and optimized via a design cycle, where individual components are designed separately and then integrated to form the whole. This fosters suboptimizations, not system-level optimizations. Engineering studies are typically done on a case-by-case basis, which grows linearly with the number of cases examined. The existing design process is a time-consuming manual process of editing elevations. Manual grading design is often slow, requiring significant time for surveys, calculations, and drafting. Manual processes are prone to errors in measurements, calculations, and interpretations, leading to inaccuracies in the final design. Grading design involves complex calculations for cut and fill, slope, and drainage. Performing these calculations manually can be difficult and less precise. Managing and updating data manually is cumbersome, especially when dealing with large volumes of information or when modifications are required.

Furthermore, manual drawings and plans cannot often provide detailed 3D visualizations, making it harder to assess the impact of the design on the landscape. Collaborating with other professionals (e.g., architects, engineers, contractors) can be more difficult without digital tools to share and update plans easily. Ensuring compliance with local regulations and standards manually can be complex and time-consuming, increasing the risk of non-compliance. Manual processes are less adaptable to changes, making it difficult to quickly revise plans based on new information or unexpected site conditions. For large-scale projects, the manual process becomes increasingly inefficient and impractical due to the sheer volume of data and complexity involved. There are automated grading optimization tools out there, but they do not output grading designs that effectively fit the input design criteria.

Therefore, there is a need for computer-implemented methods and computing systems for generating an optimal grading design for a given plot of land to overcome one or more limitations stated above, in addition to providing other technical advantages.

### SUMMARY

Various embodiments of the present disclosure provide methods and systems for generating an optimal grading design for a given plot of land. The computer-implemented method performed by a system includes generating a topography profile of a plot of land. Further, the computer-implemented method includes appending a plurality of boundaries to the topology profile. The computer-implemented method further includes determining whether a grading design satisfies usage constraints based, at least in part, on the topography profile and a usage map. Herein, the usage map includes a plurality of usage areas and corresponding usage parameters. The computer-implemented method further includes accessing a cost profile including a plurality of individual costs associated with respective land restructuring operations of the plot of land. The computer-implemented method further includes generating a modified topography profile based on the topography profile and the cost profile associated with the respective land restructuring operations of the plot of land. The modified topography profile is generated based at least on a quadratic greedy-global optimization applied to the respective land restructuring operations of the plot of land.

In another embodiment, a system is disclosed. The system includes a communication interface and a memory including executable instructions. The system also includes a processor communicably coupled to the memory. The processor is configured to execute the instructions to cause the system, at least in part, to generate a topography profile of a plot of land. Furthermore, the system is caused to append a plurality of boundaries to the topology profile. Additionally, the system is caused to determine whether a grading design satisfies usage constraints based, at least in part, on the topography profile and a usage map. Herein, the usage map includes a plurality of usage areas and corresponding usage parameters. Then, the system is caused to access a cost profile comprising a plurality of individual costs associated with respective land restructuring operations of the plot of land. Further, the system is caused to generate a modified topography profile based on the topography profile and the cost profile associated with the respective land restructuring operations of the plot of land. The modified topography profile is generated based at least on a quadratic greedy-global optimization applied to the respective land restructuring operations of the plot of land.

In yet another embodiment, a non-transitory computer-readable storage medium is disclosed. The non-transitory computer-readable storage medium includes computer-executable instructions that, when executed by at least a processor of a system, cause the system to perform a method. The method performed includes generating a topography profile of a plot of land. Further, the method includes appending a plurality of boundaries to the topology profile. The method further includes determining whether a grading design satisfies usage constraints based, at least in part, on the topography profile and a usage map. Herein, the usage map includes a plurality of usage areas and corresponding usage parameters. The method further includes accessing a cost profile including a plurality of individual costs associated with respective land restructuring operations of the plot of land. The method further includes generating a modified topography profile based on the topography profile and the cost profile associated with the respective land restructuring operations of the plot of land. The modified topography profile is generated based at least on a quadratic greedy-global optimization applied to the respective land restructuring operations of the plot of land.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The following detailed description of illustrative embodiments is better understood when read in conjunction with the appended drawings. To illustrate the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 illustrates an example representation of an environment related to at least some example embodiments of the present disclosure;

FIG. 2 illustrates a logical diagram of a controller for implementation of the present disclosure, in accordance with an embodiment of the present disclosure;

FIG. 3 illustrates a computer-implemented method for generating an optimal grading design for a given plot of land, in accordance with an embodiment of the present disclosure;

FIG. 4 illustrates a Graphical User Interface (GUI) depicting a topography profile of a plot of land, in accordance with an embodiment of the present disclosure;

FIG. 5 illustrates a GUI depicting a usage map located above the topography profile, in accordance with an embodiment of the present disclosure;

FIG. 6 illustrates the usage map superimposed onto the topography profile, in accordance with an embodiment of the present disclosure;

FIG. 7 illustrates a computer-implemented method for deploying a quadratic greedy-global optimization, in accordance with an embodiment of the present disclosure;

FIG. 8 illustrates a GUI depicting a water collection system below a finalized topography profile of the given plot of land, in accordance with an embodiment of the present disclosure;

FIG. 9 illustrates a process flow diagram depicting a method for generating an optimal grading design, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various embodiments of the present disclosure provide computer-implemented methods and computing systems for generating an optimal grading design for a given plot of land.

In an embodiment, the system is configured to generate a topography profile of a plot of land. In an embodiment, for generating the topography profile, the system is configured to access a topography database including a plurality of location points. Herein, each location point in the plurality of location points is defined by a set of coordinates comprising elevation data. The topography database is generated based on at least one of remote sensing, Light Detection and Ranging (LIDAR) imaging, Global Positioning Systems (GPS), ground surveys, Digital Elevation Models (DEMs), Photogrammetry, Geographic information systems (GIS). Then, the system is configured to generate a point cloud representation of the plot of land based, at least in part, on the plurality of location points. Herein, the point cloud representation indicates a set of spatial data collectively representing a three-dimensional surface geometry of the plot of land. In an embodiment, the system is configured to receive a predetermined density value for the point cloud representation from one or more computing devices. Then, the system is configured to adjust number of location points in the plurality of location points, based, at least in part, on the predetermined density value. Further, the system is configured to generate the topography profile of the plot of land based on the point cloud representation. The modified topography profile is generated based at least on a quadratic greedy-global optimization applied to the respective land restructuring operations of the plot of land.

In another embodiment, for generating the topography profile, the system is configured to compute for a target location point, a distance to a plurality of surrounding location points. Herein, the target location point is defined as a location point interpolation due to absence of elevation data. Then, the system is configured to determine a weight for each surrounding location point in the plurality of surrounding location points based, at least in part, on a distance between each surrounding location point and the target location point. Further, the system is configured to compute an interpolated elevation data for the target location point based, at least in part, on the determined weight of each surrounding location point.

In a non-limiting implementation, the topography profile is generated based on a plurality of profile generation techniques. Here, the plurality of profile generation techniques includes walk-through surveys, photographic analysis, utilization of hand level, abney level, clinometer, mapping techniques, local knowledge, contour mapping, sensors, and applications. Then, the system is configured to append a plurality of boundaries to the topography profile. Further, the system is configured to determine whether a grading design satisfies usage constraints based, at least in part, on the topography profile and a usage map. Herein, the usage map includes a plurality of usage areas and corresponding usage parameters. For determining whether the grading design satisfies the usage constraints, the system is configured to receive the corresponding usage parameters. Here, the corresponding usage parameters include at least one of minimum slope limits, maximum slope limits, elevation tolerances, drainage requirements, runoff requirements, soil displacement thresholds, regulatory constraints, stability constraints, infrastructure proximity limits, or functional area flatness requirements. Then, the system is configured to superimpose the usage map onto the topography profile to obtain a superimposed topography profile. Further, the system is configured to segment the superimposed topography profile into a grid of cells, each cell comprising one or more neighboring cells. Furthermore, the system is configured to propagate a subset of constraints associated with each cell from each cell to the one or more neighboring cells based, at least in part, on compliance of each cell with the subset of constraints. Then, the system is configured to evaluate whether the grading design satisfies the usage constraints based on the compliance of each cell.

Furthermore, the system is configured to access a cost profile including a plurality of individual costs associated with respective land restructuring operations of the plot of land. Then, the system is configured to generate a modified topography profile based on the topography profile and the cost profile associated with the respective land restructuring operations of the plot of land. For generating the modified topography profile, the system is configured to define a restructuring cost function for evaluating the plurality of land restructuring operations at each location point of the topography profile. Then, the system is configured to compute a restructuring cost value for each restructuring operation at each location point using the cost function. Further, the system is configured to select at least one restructuring operation from the plurality of land restructuring operations based at least the restructuring cost value corresponding to each location point. Then, the system is configured to output the modified topography profile based, at least in part, on the selected at least one operation corresponding to each location point. Further, the system is configured to filter noise from the modified topology profile to obtain a finalized topology profile. Furthermore, the system is configured to determine a corresponding cost of grading each candidate plot in a plurality of candidate plots based on the cost profile. Then, the system is configured to generate a ranked list of the candidate plots based on the corresponding cost of grading.

Various embodiments of the present disclosure offer multiple advantages and technical effects. For instance, the proposed approach is capable of automating the process of generating grading designs, which traditionally relies on manual, time-intensive, and error-prone methods. By utilizing data-driven techniques such as point cloud representations derived from remote sensing, LiDAR, and other survey technologies, the proposed approach enables accurate modeling of terrain profiles. The integration of usage maps and associated constraints ensures that the generated designs meet functional, environmental, and regulatory requirements.

Further, the proposed system incorporates a cost structure and applies quadratic greedy-global optimization to minimize the aggregated cost of land restructuring operations, such as excavation, fill, and compaction. This leads to more efficient allocation of resources and significant cost savings. Additionally, the proposed approach supports ad-hoc surveying methods and flexible input parameters, making it adaptable to a wide range of project scales and site conditions. The ability to filter noise, perform viability analysis using possibilistic frameworks, and incorporate auxiliary infrastructure elements into the final design further enhances the technical robustness and practical utility of the proposed approach. Overall, the proposed approach facilitates faster, more precise, and cost-effective land development planning while improving compliance, scalability, and collaboration among stakeholders.

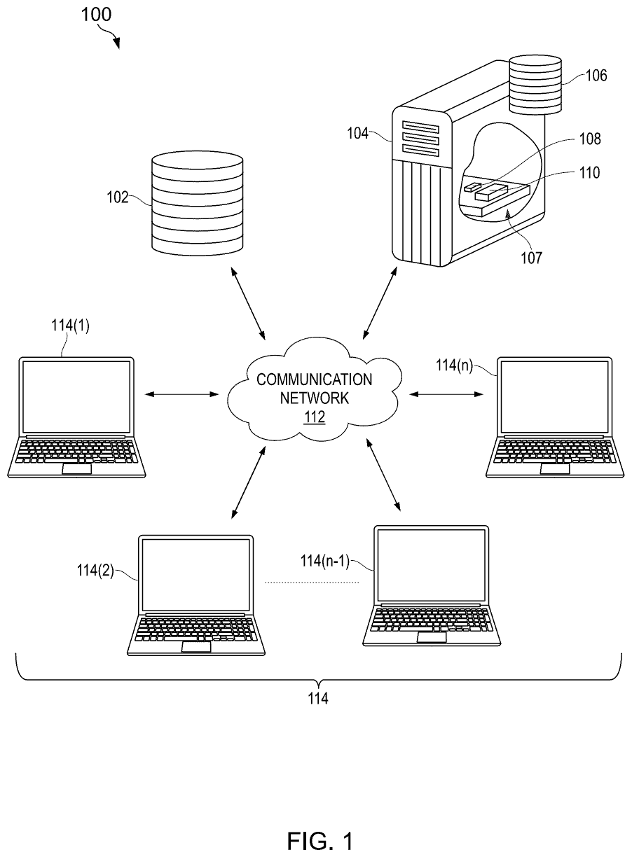

Various embodiments of the present disclosure are described with reference to FIG. 1 to FIG. 9.

FIG. 1 illustrates an example representation of an environment 100 related to at least some example embodiments of the present disclosure. The environment 100 includes a topography database maintained in a topography storage device 102. The topography storage device 102 may be a non-volatile memory device of the types including Read-Only Memory (ROM), Erasable Programmable Read-Only Memory (EPROM), Electrically Erasable Programmable Read-Only Memory (EEPROM), flash memory, and the like. The topography database is envisaged to include location coordinates of several location points at a site where land optimization needs to be performed. In that regard, in several embodiments, the topography database may include the location coordinates in respect of one or more predefined coordinate systems as will be discussed in the following discussion. There are several techniques through which the topography database may be generated. Some of the non-limiting examples include remote sensing, Light Detection and Ranging (LiDAR) imaging, Global Positioning Systems (GPS) or Ground Surveys, Digital Elevation Models (DEMs), Photogrammetry, Geographic Information Systems (GIS).

For example, remote sensing may be performed through high-resolution satellite imagery or through aerial photography using drones or aircraft equipped with high-resolution cameras. LiDAR can penetrate vegetation, providing detailed ground topography even in forested areas. GPS or Ground Surveys utilize total stations, GPS, and theodolites. DEMs are provided by space agencies such as the National Aeronautics and Space Administration (NASA) and are used for initial planning and analysis of large-scale projects. Photogrammetry involves taking measurements from photographs, typically aerial images, and using software to create 3D models of the terrain. Software tools may further be deployed to stitch multiple images together to create detailed topographical maps. GIS are predominantly software-based tools to combine satellite imagery, LiDAR data, ground survey data, DEMs, and data gathered through other sources to produce detailed topographical maps. It is to be noted here that the topography database for the site for land development may generated through government-owned infrastructure such as satellites, privately owned infrastructure such as drones and several other proprietary software tools, or through several collaborations between government agencies and private enterprises.

The environment 100 further includes a server system 104 in communication with the topography storage device 102 through a communication network 112. The server system 104 is envisaged to include several hardware capabilities including a controller 107. The controller 107 includes a processor 108 and a memory unit 110. The processor 108 may be selected from a group consisting of a microcontroller, a general-purpose processor, a System on Chip (SoC), a Field Programmable Gate Array (FPGA), an Application Specific Integrated Circuit (ASIC), and the like. The memory unit 110 may be selected from a group consisting of volatile memory units such as, but not limited to, such as Static Random Access Memory (SRAM) and Dynamic Random Access Memory (DRAM) of types such as Asynchronous DRAM, Synchronous DRAM, Double Data Rate SDRAM, Rambus DRAM, and Cache DRAM, etc. The server system 104 further includes an application data storage device 106. The application data storage device 106 may also be a non-volatile storage device selected from a group consisting of the types including ROM, EPROM, EEPROM, flash memory, and the like.

The application data storage device 106 may include permanently stored machine-readable instructions for the processor 108 to execute. The machine-readable instructions may be stored in the form of software and/or firmware. Furthermore, the application data storage device 106 may include supporting meta-data (indexes for faster data retrieval, schema definitions for structured data), external references (URLs, File Paths), cache (frequently accessed data for quick retrieval, session data), user profiles (names, contact information, preferences), authentication credentials (hashed passwords, tokens), user-generated content (files, posts, messages), system configuration (network settings, hardware configurations), operational data (error logs, access logs), usage statistics (analytics, user activity tracking), relational data (tables, rows), non-relational data (documents, collections), key-value pairs, etc.

The communication network 112 may be implemented through several combinations of wired and wireless protocols including High-Definition Multimedia Interface (HDMI) cables, Video Graphics Array (VGA) cables, Ethernet, Wireless Fidelity (Wi-Fi), Wireless Interoperability of Microwave Access (Wi-Max), Bluetooth, ZigBee, Global System for Mobile Communications (GSM), High-Speed Packet Access (HSPA), High-Speed Downlink Packet Access (HSDPA), Long Term Evolution (LTE), 5G, etc. without departing from the scope of the disclosure. In several embodiments, several extra layers of security through Secure Sockets Layer (SSL), Transport Layer Security (TLS), end-to-end encryption, use of device firewalls, and network firewalls may be built into the communication network 112. Further connected to the communication network 112 are a plurality of user computing devices 114 (for example, 114(1), 114(2) . . . 114(n-1), 114(n), where n is a natural number). The plurality of user computing devices 114, 116, 118, and 120 may be selected from a group consisting of notebook Personal Computers (PCs), desktop PCs, tablet PCs, smartphones, and the like.

The plurality of user computing devices 114 may be associated with several stakeholders involved in the generation of the optimal grading design for the given plot of land. The several stakeholders may include but are not limited to landowners (The individuals or entities who own the property and are often the primary decision-makers regarding the use and development.), design engineers (Professionals who specialize in grading, drainage, and land development. They create the grading plans and ensure that the grading plans meet design requirements and regulations), surveyors (Experts who conduct topographic surveys to provide accurate measurements of the existing elevations and features of the given plot of land, which are crucial for designing effective grading plans.), architects (Professionals who design the buildings and structures that will be placed on the site. They need to coordinate with grading design to ensure that the topography of the land supports their architectural plans), civil engineers (They handle aspects related to infrastructure, such as roadways, utilities, and stormwater management, ensuring that grading design integrates well with these elements.), environmental consultants (Specialists who assess the environmental impact of the grading design, ensuring that it adheres to regulations and minimizes ecological disruption.), regulatory authorities (Local government agencies and planning departments that review and approve grading plans to ensure compliance with zoning laws, building codes, and environmental regulations.), contractors (Construction professionals who implement the grading design on-site. They need detailed plans and specifications to accurately perform the grading work.), urban planners (Professionals who consider the broader context of the land use, including how the grading design fits into overall land use plans and development strategies.), neighbors and community members (Local residents who may be affected by the grading design, especially if it impacts drainage, view corridors, or other aspects of the surrounding area.), and legal advisors (Lawyers or legal consultants who handle any legal aspects related to land use, property disputes, or compliance with regulations.).

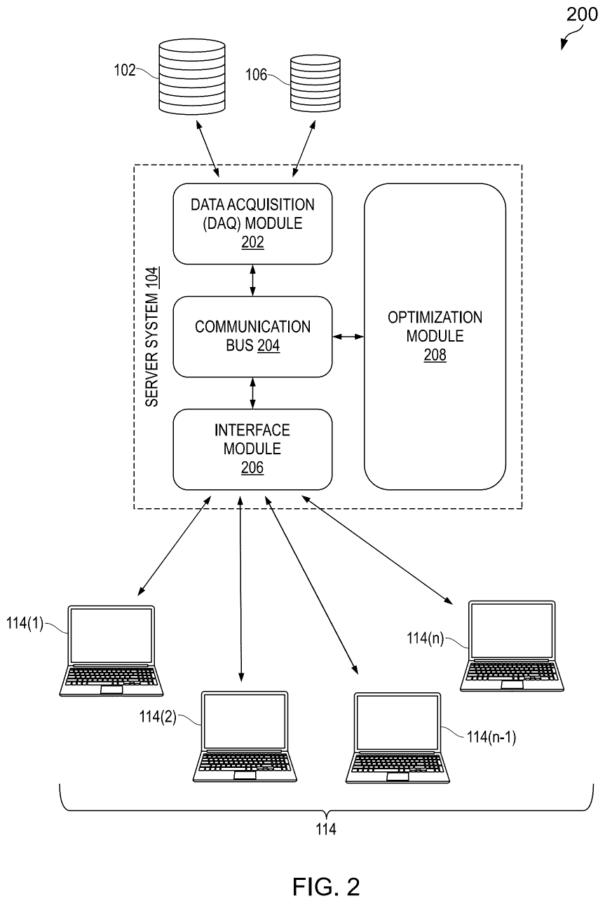

FIG. 2 illustrates a logical implementation 200 of the server system 104 for implementation of the present disclosure, in accordance with an embodiment of the present disclosure. The server system 104 includes a Data Acquisition (DAQ) module 202 in communication with the topography storage device 102 and the application data storage device 106. The DAQ module 202 may collect topography data from the topography storage device 102 and/or the application data storage device 106 through secure connections over the communication network 112. The DAQ module 202 may also leverage some of the hardware capabilities of the server system 104 such as a network card (for example, Wi-Fi, Bluetooth), DAQ ports (for example, Universal Serial Bus (USB) ports, Ethernet ports, RS-232 ports, RS-485 ports, Peripheral Component Interconnect/Peripheral Component Interconnect Express (PCI/PCIe) ports, Serial Peripheral Interface (SPI), etc.), General Purpose Interface Bus (GPIB), Controller Area Network (CAN) Bus, Modbus, etc. built into the server system 104. The collected application data and/or the topography data may then be sent by the DAQ module 202 to the processor 108 in real-time or in set intervals depending upon the application.

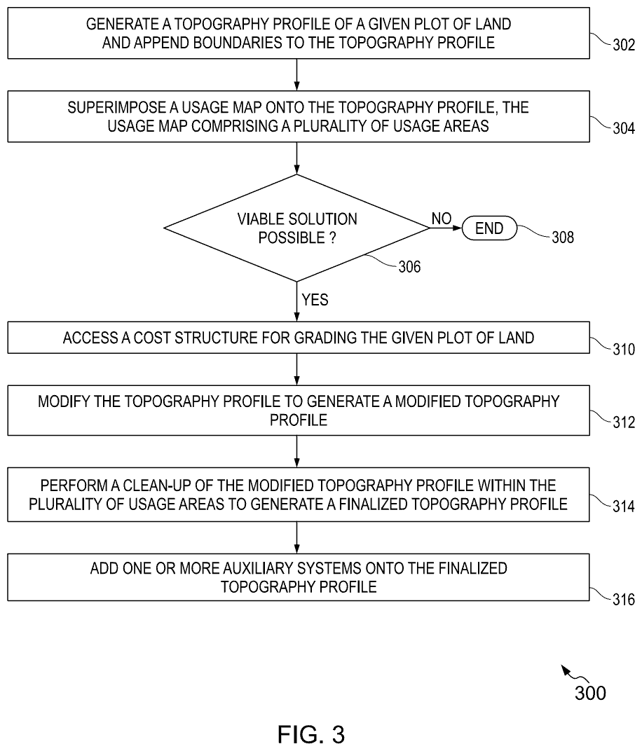

The server system 104 further includes an interface module 206. In several embodiments of the disclosure, the interface module 206 may be a combination of hardware elements such as input devices (keyboard, mouse, trackpad, trackball, microphones, etc.), output devices (speakers, LED or LCD screens, etc.), and software elements such as a Graphic User Interface (GUI) built on a general purpose, or a proprietary operating system or a kernel. The interface module 206 allows the plurality of user computing devices 114 to communicate with the controller 107. The server system 104 further includes an optimization module 208 configured to generate an optimal grading design for a given plot of land which will be discussed in conjunction with FIGS. 3-8. The DAQ module 202, the interface module 206, and the optimization module 208 communicate with each other and exchange data through a communication bus 204. The communication bus 204 may be a combination of one or more data buses for the transfer of data, one or more address buses carrying information about where the data is to be sent, and one or more control buses for carrying control signals to manage operations. The DAQ module 202, the interface module 206, the optimization module 208, and the communication bus 204 may be at least partially enabled by the processor 108 executing machine-readable instructions loaded into the memory unit 110 during runtime.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may include connected logic units, such as gates and flip-flops, and may comprise programmable units, such as programmable gate arrays or processors. The modules described herein may be implemented as either software and/or hardware modules and may be stored in any type of computer-readable medium or other computer storage device.

FIG. 3 illustrates a computer-implemented method 300 (hereinafter also referred to as “the method 300”) for generating an optimal grading design for a given plot of land, in accordance with an embodiment of the present disclosure. The method steps of the method 300 may be performed by the controller 107, through the processor 108 executing machine-readable instructions loaded into the memory unit 110 during run-time. The several modules discussed above in reference to FIG. 2 may be leveraged by the processor 108 in the execution of the following method steps.

The method 300 begins at Step 302 when the controller 107 (referred to as system hereinafter interchangeably) generates a topography profile for the given plot of land. In several embodiments. the topography profile may be generated by accessing the topography database stored in the topography storage device 102. The topography database can include a plurality of location points. Each location point in the plurality of location points is defined by a set of coordinates including the elevation data. Then, the point cloud representation of the plot of land is generated based, at least in part, on the plurality of location points. Here, the point cloud representation indicates a set of spatial data collectively representing a three-dimensional surface geometry of the plot of land. Then, the topology profile of the plot of land is generated based on the point cloud representation. As discussed above, the topography database may be generated through several means including, but not limited to, remote sensing, Light Detection and Ranging (LIDAR) imaging, Global Positioning Systems (GPS), ground surveys, Digital Elevation Models (DEMs), Photogrammetry, and Geographic information systems (GIS). In addition, an ad-hoc method of topography evaluation may also be used to generate the topography profile of the given plot of land. The advantages of the ad-hoc methods are that they are generally faster and relatively less cost-intensive.

Some of the ad-hoc methods include, but are not limited to, (1) walkthrough survey (physically walking the plot of land to visually inspect and estimate changes in elevation and identify major topographic features such as hills, valleys, and slopes), (2) photographic analysis (using photographs taken from different angles and heights to assess and approximate the topography), (3) use of simple tools (such as hand level, Abney level, and clinometer), (4) basic mapping techniques (for example, sketch mapping including drawing a rough map of the area, noting key topographic features based on visual inspection and simple measurements, and string line and stakes including using string lines and stakes to create a basic grid over the area and measuring elevation differences with a tape measure or ruler), (5) use of local knowledge (for example, gathering information from local residents or workers who are familiar with the land and its features, and referring to old maps, photographs, or documents that provide information about the topography of the plot of land), (6) simple contour mapping (for example, grid method including creating a grid over the land and measuring elevations at each grid point using basic tools, then drawing contour lines based on these measurements, and profile leveling including running a straight line across the plot and measuring elevations at regular intervals along the line to create a basic profile), and (7) use of basic technology such as sensors and applications available through smartphones.

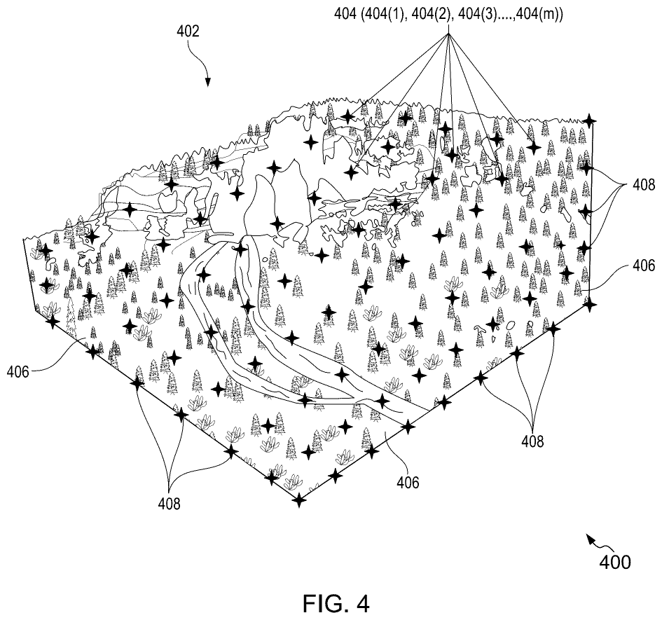

FIG. 4 illustrates a Graphical User Interface (GUI) 400 depicting a topography profile 402 of a plot of land, in accordance with an embodiment of the present disclosure. The plot before grading may include geographical features such as streams, hills, ravines, vegetation, etc., as depicted in FIG. 4. The topography profile 402 may be stored in form of a point cloud including a plurality of location points 404 (for example, 404(1), 404(2), 404(3) . . . , 404(m), where m is a natural number), each location point defined in terms of coordinates in accordance with one or more applicable coordinate systems. A coordinate system helps in accurately positioning and representing features of the given plot of land. The choice of a coordinate system often depends on the scale and purpose of the survey.

The one or more applicable coordinate systems may include, but are not limited to, a Geographic Coordinate System (GCS) (uses latitude and longitude to define positions on the Earth's surface), a Projected Coordinate System (PCS) (transforms the curved surface of Earth onto a flat plane, minimizing distortions in specific areas.), Local Coordinate Systems (custom coordinate systems set up for specific projects or sites, usually based on an arbitrary origin within the project area), etc. Furthermore, in several embodiments, the controller 107 may receive a predetermined density value for the point cloud from one or more computing devices of the plurality of user computing devices 114. The controller 107 may then adjust a number of location points of the plurality of location points 404 denoting the topography profile 402 in correlation with the predetermined density value.

In an embodiment, for interpolating altitudes of a target location point for generating the topography profile, the controller 107 is configured to perform a series of operations. Herein, the target location point can be defined as a location point interpolation due to the absence of elevation data. The series of operations may be initiated by computing for the target location point, a distance to a plurality of surrounding location points. Then, the controller 107 is configured to determine a weight for each surrounding location point in the plurality of surrounding location points. The weight for each surrounding location point is determined based, at least in part, on a distance between each surrounding location point and the target location point. Further, the controller 107 is configured to compute an interpolated elevation data for the target location point based, at least in part, on the determined weight of each surrounding location point.

More specifically, the plurality of location points 404 may be combined by the controller 107 by weighing a plurality of respective altitudes of the plurality of location points 404 by distance squared. Therefore, a weighted average is created that emphasizes closer points more strongly than farther points. For example, the plurality of location points 404 is denoted as (xᵢ, yᵢ, zᵢ)∀iϵ[1, 2 . . . , m], where m is a natural number and denotes the number of location points of the plurality of location points 404. Altitude zₜ for a target point (xₜ, yₜ) may need to be calculated. Euclidean distances di from the target point to each of the other points may be calculated as given below.

$${d}_{i} = \sqrt{( {x}_{t}^{2} - {x}_{i}^{2} ) + ( {y}_{t}^{2} - {y}_{i}^{2} )}$$

Weights wᵢ based on the inverse of the distance squared may be calculated as given below.

$${w}_{i} = \frac{1}{{d}_{i}^{2}}$$

Weighted average altitude zₜ may further be calculated as given below.

$${z}_{t} = \frac{{\sum }_{i} {w}_{i} \times {z}_{i}}{{\sum }_{i} {w}_{i}}$$

Once the topography profile has been generated, the controller 107 appends a plurality of boundaries 406 (herein after referred to as boundaries) to the topography profile 402. The boundaries 406 help define the area of interest and ensure that the topographic data is relevant to the specified plot. The generation of boundaries 406 may include the same methods as disclosed in the generation of the topography profile 402. In that regard, a detailed survey may be conducted to establish the precise location of the boundaries 406. The detailed survey may include measuring and marking corners and edges of the plot using surveying equipment such as total stations, GPS, and theodolites. Furthermore, coordinates of boundary points 408 may be collected during the boundary survey. The boundaries 406 may be generated by connecting the boundary points 408. The coordinates of the boundary points 408 are typically in a geographic or Cartesian coordinate system, but other coordinate systems discussed above may also be applicable. The coordinates of the boundary points 408 may then be integrated into the topography profile 402 thereby generating a composite topography profile 402 including both the coordinates of the boundary points 408 and the coordinates of the points 404 lying within the defined boundaries 406.

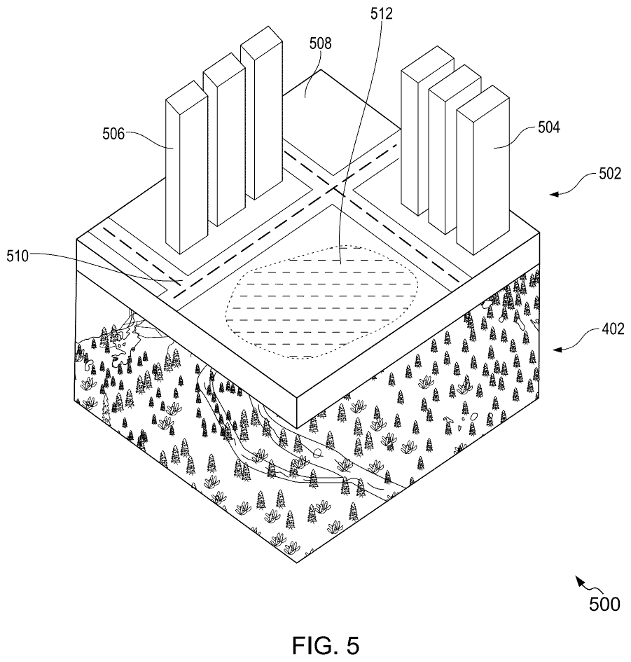

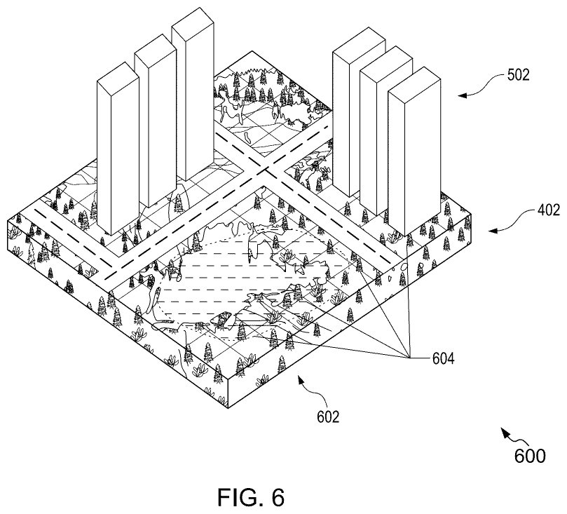

Further, the controller 107 is configured to determine whether the grading design satisfies usage constraints based at least in part, on the composite topology profile 402 (can be referred to as the topology profile 402) and the usage map. Here, the usage map includes a plurality of usage areas and corresponding usage parameters. For determining whether the grading design satisfies the usage constraints, the controller 107 is configured to perform a series of operations. The series of operations may be initiated by receiving the corresponding usage parameters. The process of receiving the corresponding usage parameters has been described in detail with reference to FIG. 5 later in the present disclosure. Then, the controller is configured to superimpose the usage map onto the topography profile 402 (see, step 304 of FIG. 3). The process of superimposing the usage map onto the topography profile 402 can generate a superimposed topography profile. Further, the controller 107 is configured to segment the superimposed topography profile into a grid of cells. Herein, each cell includes one or more neighboring cells. Then, the controller 107 is configured to propagate a subset of constraints associated with each cell from each cell to one or more neighboring. Herein, the propagation of the subset of constraints is based, at least in part, on the compliance of each cell with the subset of constraints. Then, the controller 107 is configured to evaluate whether the grading design satisfies the usage constraints based on the compliance of each cell. In other words, the controller 107 is configured to evaluate whether a viable grading design is possible to decide whether to proceed further or not. The process of superimposing the usage map onto the topography profile, segmenting the superimposed topography profile, and evaluating the viability of the grading design has been described in detail with reference to FIG. 6.

FIG. 5 illustrates a GUI 500 depicting a usage map 502 located above the topography profile 402, in accordance with an embodiment of the present disclosure. The usage map 502 includes a plurality of usage areas, such as, but not limited to, a commercial complex 504, a residential complex 506, a community area 508, several roads 510, and a water reservoir 512. In addition, in several embodiments, the plurality of usage areas may further include parking lots, foundations, sidewalks, etc. Furthermore, for the usage map 502, the controller 107 may also receive the corresponding usage parameters. Herein, the corresponding usage parameters can include a set of constraints. In various examples, the set of constraints may include, but is not limited to, at least one of minimum slope limits, maximum slope limits, elevation tolerances, drainage requirements, runoff requirements, soil displacement thresholds, regulatory constraints, stability constraints, infrastructure proximity limits, or functional area flatness requirements, and allowed variability in altitudes.

FIG. 6 illustrates the usage map 502 superimposed onto the topography profile 402, in accordance with an embodiment of the present disclosure. Furthermore, the superimposed combination of the usage map 502 and the topography profile 402 has been divided into a grid 602 of a plurality of cells 604. In the grid 602, each cell of the plurality of cells 604 has neighbors in north, south, cast, and west directions.

Referring to FIG. 3, at Step 306, the controller 107 checks if a viable solution is possible. In that regard, the controller 107 considers the topography profile 402, the usage map 502, and the plurality of predetermined usage area parameters to perform a possibilistic analysis to determine the possibility of a viable solution. Possibilistic analysis is a mathematical and computational framework used to handle and analyze uncertainty in systems where information is imprecise, incomplete, or ambiguous. Unlike probabilistic analysis, which relies on precise probabilities, possibilistic analysis deals with the degree of possibility and necessity of events. The possibilistic analysis framework is particularly useful in areas such as decision-making, artificial intelligence, and expert systems, where uncertainty is not easily quantified using traditional probability theory. The possibilistic analysis framework deploys concepts such as possibility distribution, necessity measure, fuzzy sets, and possibility theory.

Possibility distribution represents the degree of possibility of various outcomes or states. Possibility distribution is a function that assigns a possibility value between 0 and 1 to each outcome, where 1 indicates full possibility and 0 indicates impossibility. Necessity measure complements a possibility measure by representing the degree of certainty that an event will occur. If an event has a high necessity, it is almost certain to happen. Furthermore, possibilistic analysis often employs fuzzy sets, which allow partial membership of elements in a set, characterized by a membership function that assigns a degree of membership ranging from 0 to 1. Possibility theory is a mathematical theory that extends fuzzy set theory to handle uncertainty. Possibility theory uses possibility distributions to model uncertain information and provides tools for combining and manipulating these distributions.

In that regard, in several embodiments, to perform the possibilistic analysis, the controller 107 determines the boundaries 406, and then messages are passed in all four directions of a rectilinear system. In possibilistic analysis, a rectilinear system typically refers to a system or a model where the relationships or interactions between variables are linear and aligned with the coordinate axes. In other words, changes in one variable do not directly cause changes in another unless explicitly defined by the linear relationships. Furthermore, a rectilinear system would imply that the uncertainties or fuzziness in the system can be modeled using linear possibility distributions and constraints. This simplifies the analysis and decision-making process by allowing the use of linear programming techniques and other linear analysis methods. Sending messages in all four directions refers to the process of transmitting information from one cell to neighboring cells of the plurality of cells 604. For instance, if an origin cell has a possibility of 0.9, adjacent cells might have a possibility of 0.6, reflecting a lower certainty due to the increased distance and dispersion.

However, a person skilled in the art would appreciate that the present disclosure is not limited to rectilinear systems alone. Other alternative systems may also be deployed for performing the possibilistic analysis without departing from the scope of the disclosure. Some of the examples include triangular and hexagonal grids, Voronoi diagrams, graph-based models, continuous space models, adaptive meshes, agent-based models, hybrid models, etc. If a viable solution is not possible then the method 300 proceeds to Step 308 and the method 300 ends. If a viable solution is possible, the method 300 proceeds to Step 310.

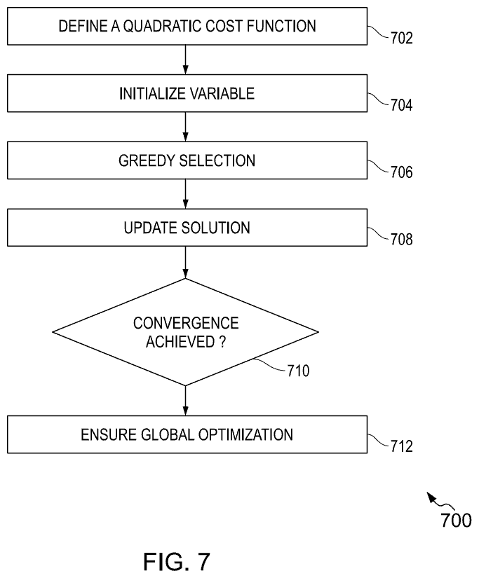

At Step 310, the controller 107 accesses a cost profile (hereinafter referred to as cost structure interchangeably) for grading the given plot of land. In that regard, the cost structure may include a plurality of individual costs associated with the respective land restructuring operation of the plot of land. The cost structure may be accessed through several locally available or web-based databases. Furthermore, in several embodiments, the cost structure may be provided by one or more stakeholders through the plurality of user computing devices 114. The plurality of land restructuring operations may include but are not limited to, digging up earth, moving the earth, dumping and compacting the earth, the removal and disposal of earth, and the sourcing and delivery of new fill earth. Furthermore, the controller 107 is configured to generate a modified topography profile based on the topography profile and the cost associated with the respective land restructuring operations of the plot of land. In other words, the controller 107 modifies the topography profile 402 to achieve a minimized aggregated cost of the respective land restructuring operations. For generating the modified topography profile while achieving the minimized aggregated cost, the controller is configured to perform a series of operations. The series of operations may be initiated by defining a restructuring cost function for the plurality of land restructuring operations at each location point of the topography profile. Then, the controller 107 is configured to compute a restructuring cost value for each restructuring operation at each location point using the cost function. Then, the controller 107 is configured to select at least one restructuring operation from the plurality of land restructuring operations based at least the restructuring cost value corresponding to each location point. Moreover, the controller 107 is configured to output the modified topography profile based, at least in part, on the selected at least one operation corresponding to each location point. In several embodiments, to achieve the minimized aggregated cost, the controller 107 deploys quadratic greedy-global optimization utilizing the cost structure. The deployment of the quadratic greedy-global optimization has been described in detail with reference to FIG. 7 later in the present disclosure.

FIG. 7 illustrates a computer-implemented method 700 (hereinafter also referred to as “the method 700”) for deploying the quadratic greedy-global optimization, in accordance with an embodiment of the present disclosure. The method 700 begins at Step 702 when the controller 107 defines a quadratic cost function (i.e., restructuring cost function) for evaluating the respective land restructuring operations of the plot of land. In other words, a choice of land restructuring operation from the plurality of land restructuring operations may then act as decision variables for the quadratic cost function. There are several advantages to using the quadratic cost functions. Quadratic functions are relatively simple and smooth, which makes them easier to analyze and optimize compared to more complex functions. The mathematical properties of quadratic functions are well-understood, allowing for efficient computation and optimization. Furthermore, if the quadratic cost function is convex, it ensures that any local minimum is also the global minimum, simplifying the optimization process. Furthermore, convexity reduces the risk of getting stuck in local minima, which is a common problem in optimization. Greedy algorithms rely on making the best local choice at each step. The smooth nature of quadratic functions makes it easier to evaluate and compare local choices. Each step in the quadratic cost function can be efficiently computed, allowing for rapid iterations in the greedy algorithm. In other words, the quadratic greedy-global optimization is deployed to perform iterative greedy selections of restructuring operations for the plurality of location points of the plot of land based on the quadratic cost function. The behavior of quadratic functions is predictable, which aids in designing and implementing optimization algorithms. Understanding the curvature of the quadratic function and rate of change helps in setting appropriate step sizes and convergence criteria.

At Step 704, the controller 107 initializes the variable at a first point (x₁, y₁, z₁) in the topography profile 402. For example, a land restructuring operation (digging up earth) may be selected for the first point (x₁, y₁, z₁). The choice of land restructuring operation may be a random guess or based on prior knowledge. Based on the selection of the land restructuring operation, the cost (i.e., the restructuring cost value) involved at the first point (x₁, y₁, z₁) may be determined from the cost structure.

At Step 706, controller 107 performs a greedy selection. For example, for a given point, the controller may evaluate the quadratic cost function. Furthermore, the controller 107 identifies a local candidate solution by making minor adjustments to the decision variables (such as a land restructuring operation). In other words, the quadratic cost function includes the decision variables representing the respective land restructuring operations at the plurality of location points of the plot of land. Furthermore, the controller 107 determines a cost (i.e., the restructuring cost value) for each candidate solution utilizing the cost structure.

At Step 708, the controller 107 updates the local candidate solution by selecting the candidate solution that provides the greatest reduction in the cost function (greedy choice). In other words, this refers to the process of selecting the at least one restructuring operation from the plurality of land restructuring operations based at least the restructuring cost value corresponding to each location point.

At Step 710, the controller 107 determines if convergence has been achieved. This can be done by checking if the change in the cost function or the decision variables between iterations is below a certain threshold. In other words, the controller 107 deploys the quadratic greedy-global optimization to apply a convergence criteria based on changes in the quadratic cost function between successive iterations. If convergence has not been achieved the method 700 returns to Step 706. If convergence has been achieved, then the method 700 proceeds to Step 712.

At Step 712, the controller 107 ensures global optimization. The controller 107 ensures that the total aggregated cost has been achieved for the plurality of land restructuring operations. In several embodiments, to ensure global optimization, multiple starting points can be used to explore different regions of the cost function landscape. In several embodiments, techniques such as simulated annealing or genetic algorithms may be incorporated to avoid local minima and enhance the probability of finding the global minimum.

Once the quadratic greedy-global optimization has been performed, a land restructuring operation has been assigned to each point in the topography profile 402 thereby generating a modified topography profile because of the land restructuring operations. The modified topography profile is therefore indicative of minimized aggregated cost of the plurality of land restructuring operations.

Referring to FIG. 3, at Step 314, the controller 107, performs a clean-up of the modified topography profile within the plurality of usage areas to generate a finalized topography profile. In an embodiment, the controller 107 is configured to filter noise from the modified topology profile to obtain a finalized topology profile. For example, the controller 107 may apply filters to remove noise. Common filters include median filters, Gaussian filters, and low-pass filters. The controller 107 may further identify and remove outliers that significantly deviate from the surrounding data points. Statistical methods such as Z-score or interquartile range (IQR) can be used to detect outliers. The controller 107 may then perform interpolation by filling in missing data points using interpolation methods like linear interpolation, spline interpolation, or Kriging. The controller 107 may also apply smoothing techniques, such as Spline Smoothing or Savitzky-Golay Filter to create a more continuous surface.

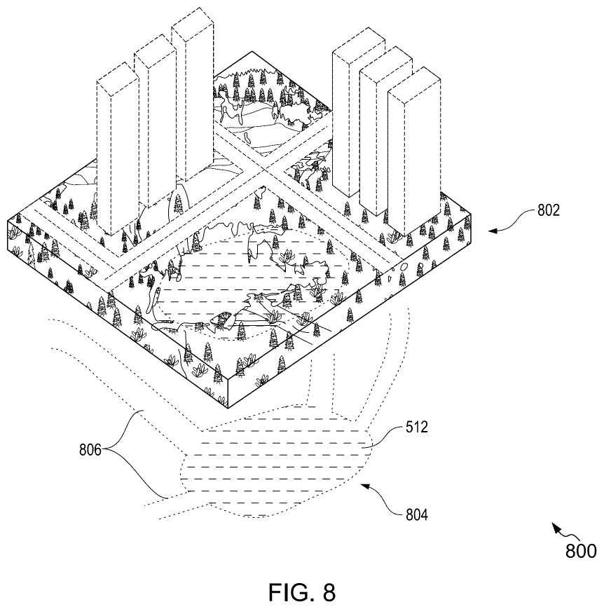

At Step 316, the controller 107 adds one or more auxiliary systems onto the finalized topography profile. FIG. 8 illustrates a GUI 800 depicting a water collection system 804 below a finalized topography profile 802 of the given plot of land, in accordance with an embodiment of the present disclosure. The water collection system 804 includes a plurality of water channels 806 running from different regions of the usage map 502 into the water reservoir 512. The one or more auxiliary systems may further include complete land development solutions, including all the buildings or engineering systems. Such land development solutions could include commercial land development, like restaurants or offices.

Furthermore, in several embodiments, the controller 107 may be configured to obtain topography profiles of a plurality of candidate plots from the topography database. Then, the controller 107 configured to determine a corresponding cost of grading each candidate plot in the plurality of candidate plots based on the cost profile. Then, the controller is configured to generate a ranked list of the candidate plots based on the corresponding cost of grading.

In an extended implementation, an operational version of the proposed approach has been developed specifically for photovoltaic (PV) system design. In this context, the proposed approach not only performs grading optimization but also incorporates pile cost optimization to achieve a cost-effective combination of earthwork and structural elements. The enhanced capabilities include an economic analysis and optimization module, which accounts for additional cost parameters such as cut, fill, movement, and haul operations. Furthermore, the proposed approach has been upgraded to support geotechnical inputs, allowing for accurate modeling of ground layers and varying material types. These enhancements improve the applicability of the proposed approach in real-world conditions and enable more precise, site-aware design outputs.

To efficiently solve complex grading and cost optimization problems, the proposed approach leverages a combination of linear and quadratic solvers. The problem domain is first clustered into sub-regions, allowing parallelized and hierarchical execution of solvers to improve scalability and processing speed. This architecture enables detailed and high-resolution optimization outcomes that outperform conventional tools in both efficiency and fidelity. The proposed approach has been implemented in Java and designed to be fully multi-threaded, supporting fast concurrent execution. It integrates with third-party libraries for linear and quadratic programming (LP/QP) and interfaces with Triangulated Irregular Network (TIN) data formats. These technological choices provide a robust, high-performance foundation for terrain-aware and economically optimized land development planning. Future developments include expanding the proposed approach's capabilities to cover broader aspects of PV system design, thereby enabling end-to-end optimization of the entire solar project lifecycle.

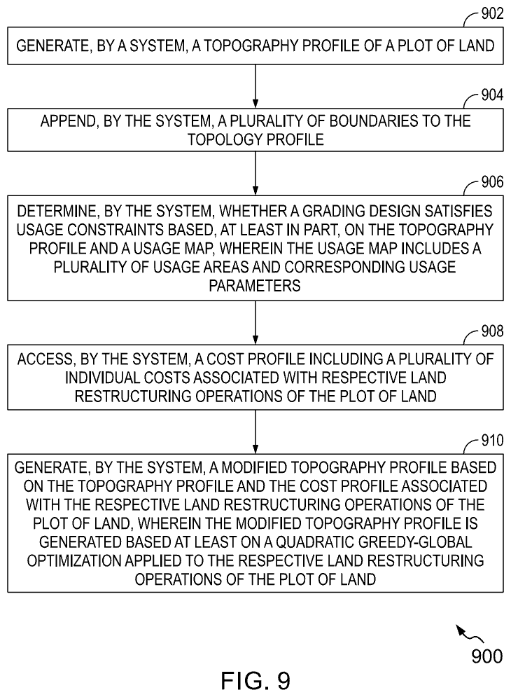

FIG. 9 illustrates a process flow diagram depicting a method 900 for generating an optimal grading design, in accordance with an embodiment of the present disclosure. The method 900 depicted in the flow diagram may be executed by, for example, the system 107. The sequence of operations of the method 900 may not necessarily be executed in the same order as they are presented. Further, one or more operations may be grouped and performed in the form of a single step, or one operation may have several sub-steps that may be performed in parallel or in a sequential manner. Operations of the method 900, and combinations of operations in the method 900 may be implemented by, for example, hardware, firmware, a processor, circuitry, and/or a different device associated with the execution of software that includes one or more computer program instructions. The plurality of operations is depicted in the process flow of the method 900. The process flow starts at operation 902.

At operation 902, the method 900 includes generating, by a system 107, a topography profile 402 of a plot of land.

At operation 904, the method 900 includes appending, by the system 107, a plurality of boundaries 406 to the topology profile 402.

At operation 906, the method 900 includes determining, by the system 107, whether a grading design satisfies usage constraints based, at least in part, on the topography profile 402 and a usage map 502. Herein, the usage map 502 includes a plurality of usage areas and corresponding usage parameters.

At operation 908, the method 900 includes accessing, by the system, a cost profile comprising a plurality of individual costs associated with respective land restructuring operations of the plot of land.

At operation 910, the method 900 includes generating, by the system, a modified topography profile based on the topography profile 402 and the cost profile associated with the respective land restructuring operations of the plot of land. The modified topography profile is generated based at least on a quadratic greedy-global optimization applied to the respective land restructuring operations of the plot of land.

Various embodiments of the disclosure, as discussed above, may be practiced with steps and/or operations in a different order, and/or with hardware elements in configurations that are different than those which are disclosed. Therefore, although the disclosure has been described based on these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
generating, by a system, a topography profile of a plot of land;
appending, by the system, a plurality of boundaries to the topology profile;
determining, by the system, whether a grading design satisfies usage constraints based, at least in part, on the topography profile and a usage map, wherein the usage map comprises a plurality of usage areas and corresponding usage parameters;
accessing, by the system, a cost profile comprising a plurality of individual costs associated with respective land restructuring operations of the plot of land; and
generating, by the system, a modified topography profile based on the topography profile and the cost profile associated with the respective land restructuring operations of the plot of land, wherein the modified topography profile is generated based at least on a quadratic greedy-global optimization applied to the respective land restructuring operations of the plot of land.

2. The computer-implemented method as claimed in claim 1, wherein generating the topography profile comprises:
accessing, by the system, a topography database comprising a plurality of location points, wherein each location point in the plurality of location points is defined by a set of coordinates comprising elevation data;
generating, by the system, a point cloud representation of the plot of land based, at least in part, on the plurality of location points, wherein the point cloud representation indicates a set of spatial data collectively representing a three-dimensional surface geometry of the plot of land; and
generating, by the system, the topography profile of the plot of land based on the point cloud representation.

3. The computer-implemented method as claimed in claim 2, further comprising:
receiving, by the system, a predetermined density value for the point cloud representation from one or more computing devices; and
adjusting, by the system, number of location points in the plurality of location points, based, at least in part, on the predetermined density value.

4. The computer-implemented method as claimed in claim 2, wherein the topography database is generated based on at least one of remote sensing, Light Detection and Ranging (LIDAR) imaging, Global Positioning Systems (GPS), ground surveys, Digital Elevation Models (DEMs), Photogrammetry, Geographic information systems (GIS).

5. The computer-implemented method as claimed in claim 1, wherein generating the topography profile comprises:
computing, by the system, for a target location point, a distance to a plurality of surrounding location points, wherein the target location point is defined as a location point interpolation due to absence of elevation data;
determining, by the system, a weight for each surrounding location point in the plurality of surrounding location points based, at least in part, on a distance between each surrounding location point and the target location point; and
computing, by the system, an interpolated elevation data for the target location point based, at least in part, on the determined weight of each surrounding location point.

6. The computer-implemented method as claimed in claim 1, wherein the topography profile is generated based on a plurality of profile generation techniques, the plurality of profile generation techniques comprising walk-through surveys, photographic analysis, utilization of hand level, abney level, clinometer, mapping techniques, local knowledge, contour mapping, sensors, and applications.

7. The computer-implemented method as claimed in claim 1, further comprising:
obtaining, by the system, a finalized topology profile based at least on removing noise from the modified topology profile being generated by applying the quadratic greedy-global optimization,
wherein deploying the quadratic greedy-global optimization comprises defining a quadratic cost function for evaluating the respective land restructuring operations of the plot of land,
wherein the quadratic cost function comprises decision variables representing the respective land restructuring operations at a plurality of location points of the plot of land, and
wherein deploying the quadratic greedy-global optimization comprises performing iterative greedy selections of restructuring operations for the plurality of location points of the plot of land based on the quadratic cost function.

8. The computer-implemented method as claimed in claim 1, wherein determining whether the grading design satisfies the usage constraints comprises:
receiving, by the system, the corresponding usage parameters comprising a set of constraints, wherein the set of constraints comprises at least one of minimum slope limits, maximum slope limits, elevation tolerances, drainage requirements, runoff requirements, soil displacement thresholds, regulatory constraints, stability constraints, infrastructure proximity limits, or functional area flatness requirements;
superimposing, by the system, the usage map onto the topography profile to obtain a superimposed topography profile;
segmenting, by the system, the superimposed topography profile into a grid of cells, each cell comprising one or more neighboring cells;
propagating, by the system, a subset of constraints associated with each cell from each cell to the one or more neighboring cells based, at least in part, on compliance of each cell with the subset of constraints; and
evaluating, by the system, whether the grading design satisfies the usage constraints based on the compliance of each cell.

9. The computer-implemented method as claimed in claim 1, wherein generating the modified topography profile comprises:
defining, by the system, a restructuring cost function for evaluating the plurality of land restructuring operations at each location point of the topography profile;
computing, by the system, a restructuring cost value for each restructuring operation at each location point using the cost function;
selecting, by the system, at least one restructuring operation from the plurality of land restructuring operations based at least the restructuring cost value corresponding to each location point; and
outputting, by the system, the modified topography profile based, at least in part, on the selected at least one operation corresponding to each location point.

10. The computer-implemented method as claimed in claim 1, further comprising:
determining, by the system, a corresponding cost of grading each candidate plot in a plurality of candidate plots based on the cost profile; and
generating, by the system, a ranked list of the candidate plots based on the corresponding cost of grading.

11. A system, comprising:
a communication interface;
a memory comprising executable instructions; and
a processor communicably coupled to the communication interface and the memory, the processor configured to cause the system to at least:
generate topography profile of a plot of land;
append a plurality of boundaries to the topology profile;
determine whether a grading design satisfies usage constraints based, at least in part, on the topography profile and a usage map, wherein the usage map comprises a plurality of usage areas and corresponding usage parameters;
access a cost profile comprising a plurality of individual costs associated with respective land restructuring operations of the plot of land; and
generate a modified topography profile based on the topography profile and the cost profile associated with the respective land restructuring operations of the plot of land, wherein the modified topography profile is generated based at least on a quadratic greedy-global optimization applied to the respective land restructuring operations of the plot of land.

12. The system as claimed in claim 11, wherein to generate the topography profile, the system is further caused, at least in part, to:
access a topography database comprising a plurality of location points, wherein each location point in the plurality of location points is defined by a set of coordinates comprising elevation data;
generate a point cloud representation of the plot of land based, at least in part, on the plurality of location points, wherein the point cloud representation indicates a set of spatial data collectively representing a three-dimensional surface geometry of the plot of land; and
generate the topography profile of the plot of land based on the point cloud representation.

13. The system as claimed in claim 12, wherein the system is further caused, at least in part, to:
receive a predetermined density value for the point cloud representation from one or more computing devices; and
adjust number of location points in the plurality of location points, based, at least in part, on the predetermined density value.

14. The system as claimed in claim 12, wherein the topography database is generated based on at least one of remote sensing, Light Detection and Ranging (LIDAR) imaging, Global Positioning Systems (GPS), ground surveys, Digital Elevation Models (DEMs), Photogrammetry, Geographic information systems (GIS).

15. The system as claimed in claim 11, wherein to generate the topography profile, the system is further caused, at least in part, to:
compute for a target location point, a distance to a plurality of surrounding location points, wherein the target location point is defined as a location point interpolation due to absence of elevation data;
determine a weight for each surrounding location point in the plurality of surrounding location points based, at least in part, on a distance between each surrounding location point and the target location point; and
compute an interpolated elevation data for the target location point based, at least in part, on the determined weight of each surrounding location point.

16. The system as claimed in claim 11, wherein the topography profile is generated based on a plurality of profile generation techniques, the plurality of profile generation techniques comprising walk-through surveys, photographic analysis, utilization of hand level, abney level, clinometer, mapping techniques, local knowledge, contour mapping, sensors, and applications.

17. The system as claimed in claim 11, wherein the system is further caused, at least in part, to:
obtain a finalized topology profile based at least on removing noise from the modified topology profile being generated by applying the quadratic greedy-global optimization,
wherein deploying the quadratic greedy-global optimization comprises defining a quadratic cost function for evaluating the respective land restructuring operations of the plot of land,
wherein the quadratic cost function comprises decision variables representing the respective land restructuring operations at a plurality of location points of the plot of land, and
wherein deploying the quadratic greedy-global optimization comprises performing iterative greedy selections of restructuring operations for the plurality of location points of the plot of land based on the quadratic cost function.

18. The system as claimed in claim 11, wherein to determine whether the grading design satisfies the usage constraints, the system is further caused, at least in part, to:
receive the corresponding usage parameters comprising a set of constraints, wherein the set of constraints comprises at least one of minimum slope limits, maximum slope limits, elevation tolerances, drainage requirements, runoff requirements, soil displacement thresholds, regulatory constraints, stability constraints, infrastructure proximity limits, or functional area flatness requirements;
superimpose the usage map onto the topography profile to obtain a superimposed topography profile;
segment the superimposed topography profile into a grid of cells, each cell comprising one or more neighboring cells;
propagate a subset of constraints associated with each cell from each cell to the one or more neighboring cells based, at least in part, on compliance of each cell with the subset of constraints; and
evaluate the viability of the grading design based on the compliance of each cell.

19. The system as claimed in claim 11, wherein to generate the modified topography profile, the system is further caused, at least in part, to:
define a restructuring cost function for evaluating the plurality of land restructuring operations at each location point of the topography profile;
compute a restructuring cost value for each restructuring operation at each location point using the cost function;
select at least one restructuring operation from the plurality of land restructuring operations based at least the restructuring cost value corresponding to each location point; and
output the modified topography profile based, at least in part, on the selected at least one operation corresponding to each location point.

20. A non-transitory computer-readable storage medium comprising computer-executable instructions that, when executed by at least a processor of a system, cause the system to perform a method comprising:
generating a topography profile of a plot of land;
appending a plurality of boundaries to the topology profile;
determining whether a grading design satisfies usage constraints based, at least in part, on the topography profile and a usage map, wherein the usage map comprises a plurality of usage areas and corresponding usage parameters;
accessing a cost profile comprising a plurality of individual costs associated with respective land restructuring operations of the plot of land; and
generating a modified topography profile based on the topography profile and the cost profile associated with the respective land restructuring operations of the plot of land, wherein the modified topography profile is generated based at least on a quadratic greedy-global optimization applied to the respective land restructuring operations of the plot of land.
